(19) United States
(12) Patent Application Publication
(10) Pub. No.: US 2009/0250511 A1
(43) Pub. Date: Oct. 8, 2009

(54) Domestic Appliance

(75) Inventor: Arved Hübler, Chemnitz (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: EVONIK DUGUSSA GMBH, ESSEN (DE)

(21) Appl. No.: 12/309,723

(22) PCT Filed: Jun. 27, 2007
(86) PCT No.: PCT/EP2007/056436

§ 371 Date: Jan. 27, 2009

(30) Foreign Application Priority Data
Aug. 25, 2006 (DE) 10-2006-039-926.9

(51) Int. Cl. G06F 17/00

(52) U.S. Cl. 235/375

(57) ABSTRACT

The invention relates to a domestic appliance comprising a read device and at least one information card, the latter containing a code arrangement that can be read by the read device and that controls the domestic appliance. The code arrangement consists of conductive organic polymers.

The invention relates to a domestic appliance with a reading device and at least one information card, wherein the information card contains a code arrangement which can be read by the reading device and which serves to control the domestic appliance.

Today wide use is made of a large number of domestic appliances, such as washing machines, laundry driers, dishwashers, stoves, ovens and microwave ovens, that are controlled by complex electronic systems. The user is in a position to influence the particular processing programme individually by manually adjusting, for example, the processing time, temperatures, etc. When making these adjustments, the user must take into account the properties of the article to be processed (laundry item, frozen pizza, etc.), but also the properties of additives, for example detergent, degree of water hardness, etc. The adjustments may influence the process as a whole for the entire duration thereof or may take effect only time-selectively (example: the oven is to be operated first of all for 10 minutes in circulating-air operation at 180° C. and then for 5 minutes with upper heat at 210° C.).

In order to facilitate such adjustments, it is already known from EP-A-1 622 425 to connect a bar code reading device to a kitchen device, for example a microwave oven, and to activate the device by inserting a bar code card.

However, an optical reading device is required for reading the bar code and this is relatively complex and therefore also expensive to produce. In the case of simple bar code readers having a slot reader with CCD elements, there is the additional problem of the optical elements becoming soiled very quickly through paper dust. The actual bar code can also become impossible to read through overwriting, dirt, adhesive labels etc.

The object of the invention is therefore to provide a code arrangement for an information card for controlling a domestic appliance which can be read with a simple and inexpensive reading device. Furthermore, it should also be possible to produce the information card and in particular the code arrangement thereof in a simple and inexpensive manner.

This object is achieved according to the invention by the features of claim 1.

The domestic appliance according to the invention has a reading device and at least one information card, the information card containing a code arrangement which can be read by the reading device and which serves to control the domestic appliance. Here the code arrangement comprises conductive organic polymers.

An inexpensive reading device which reads out the code arrangement, for example by means of an inductive, a capacitive or an ohmic coupling, is in particular possible through the code arrangement. There is also the possibility of printing the code arrangement and, in this connection, of using, in particular, mass printing processes.

Further configurations of the invention constitute the subject matter of the subordinate claims.

According to one preferred embodiment, the information card consists of two flexible substrate layers which can consist in particular of paper or of film. The code arrangement can in this case be invisibly embedded between the two substrate layers. This results in the possibility of forming or printing the information card on its top side and/or underside in a completely free manner. Suitable conductive organic polymers are, for example, PEDOT or PANI.

When compared with a bar code, the code arrangement comprising conductive organic polymers also has above all the advantage of reliable readability as the structure can be disposed in a protected manner between two substrate layers.

Further advantages and configurations of the invention are explained in detail in the following on the basis of the description and the drawings.

In the drawings

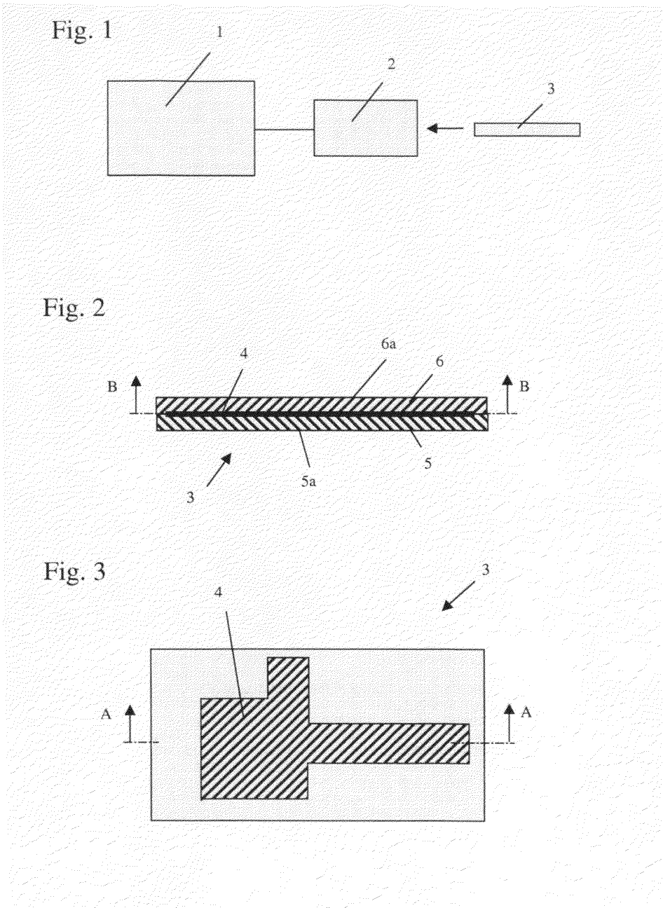

FIG. 1 is a block diagram of the domestic appliance with an information card,

FIG. 2 is a longitudinal sectional representation along the line A-A of FIG. 3 and

FIG. 3 is a sectional representation along the line B-B of FIG. 2.

FIG. 1 shows a domestic appliance 1 and a reading device 2, the reading device 2 being either integrated in the domestic appliance or connectable as an external device to the domestic appliance. The connection can be effected via a cable or in a contactless manner. An information card 3 can be inserted into the reading device 2. The information card 3, which is represented in more detail in FIGS. 2 and 3, comprises a code arrangement 4 which serves to control the domestic appliance 1 in order to achieve a specific objective.

The information card 3 preferably consists of two flexible substrate layers 5, 6 which can in particular consist of paper or film. The code arrangement 4 is advantageously invisibly embedded between the two substrate layers 5, 6, as can be seen from FIG. 2. Joining can be effected by lamination, for example, or in another way. The code arrangement 4 comprises conductive organic polymers, for example PEDOT or PANI.

The information cards can be produced particularly inexpensively if the conductive organic polymers are produced by means of a mass printing process, in particular a letterpress, an intaglio or a planographic printing process.

Since the code arrangement is embedded between the two substrates, it is possible to form or to print the top side and/or underside 6a, 5a of the information card in any desired manner without having to keep a certain area free for a code arrangement.

Various configurations of the reading device 2 are conceivable for reading the code arrangement. For example, particular possibilities are an inductive or a capacitive coupling, but also an ohmic contact.

The object of the invention is to enable, in a simple and inexpensive manner, the information necessary for programming the domestic appliance to be read directly into the system without manual intervention. For this purpose, the information is deposited on the information card which is provided with the products (such as, for example, frozen pizza, detergent, etc.) by the manufacturer. By inserting the information card, the stored information is automatically passed on to the appliance control system.

It is particularly attractive to manufacture the information cards with a code arrangement which can be printed by means of mass printing processes, so that costs remain within realistic bounds for everyday products.

The information card can be enclosed, for example, as a separate card with the article (frozen food) or can be integrated in the surrounding packaging. The card is then separated from the surrounding packaging and inserted into the reading device.

In the case of washing machines, it would be possible for the manufacturer to enclose information cards for the various programmes and for the user to select the programme cards which he normally wishes to use. It is thus possible to activate the appliance in a very rapid and simple manner.

1. Domestic appliance comprising a reading device and at least one information card, wherein the information card contains a code arrangement which can be read by the reading device and which serves to control the domestic appliance, and wherein the code arrangement comprises conductive organic polymers; and wherein the reading device is formed such that it reads out the code arrangement by means of a capacitive coupling to the information card.

2. The domestic appliance according to claim 1, wherein the information card comprises at least one flexible substrate layer which is composed of paper or film.

3. The domestic appliance according to claim 1, wherein the code arrangement is invisibly embedded between two substrate layers.

4. The domestic appliance according to claim 2 wherein the information card is printed on its top side, underside, or both sides.

5. The domestic appliance according to claim 1, wherein the information card is of flexible formation.

6. The domestic appliance according to claim 1, wherein the conductive organic polymers consist of PEDOT.

7. The domestic appliance according to claim 1, wherein the conductive organic polymers consist of PANI.

8. (canceled)

9. The domestic appliance according to claim 1, wherein the conductive organic polymers are produced by means of a mass printing process selected from the group consisting of a letterpress, an intaglio and a planographic printing process.
